(19) United States
(12) Patent Application Publication
(10) Pub. No.: US 2024/0064360 A1
(43) Pub. Date: Feb. 22, 2024

(54) DISTRIBUTION CONTROL APPARATUS, DISTRIBUTION CONTROL SYSTEM, DISTRIBUTION CONTROL METHOD AND PROGRAM

(71) Applicant: NIPPON TELEGRAPH AND TELEPHONE CORPORATION, Tokyo (JP)

(72) Inventors: Xiaotian ZHAO, Tokyo (JP); Takafumi OKUYAMA, Tokyo (JP); Hiroyuki KITADA, Tokyo (JP)

(21) Appl. No.: 18/260,106

(22) PCT Filed: Jan. 5, 2021
(86) PCT No.: PCT/JP2021/000101

§ 371 Date: Jun. 30, 2023

(51) Int. Cl. H04N 21/2662; G06T 15/20

(52) U.S. Cl. CPC H04N 21/2662; G06T 15/20; G06T 2210/08; G06T 2200/16; G06T 2210/36

(57) ABSTRACT

A distribution control device configured to distribute three-dimensional video data including a plurality of meshlets and a texture of each meshlet to a client PC, the device comprising: a distribution control unit configured to select a high-quality meshlet as a meshlet under a viewpoint of a user based on information regarding the viewpoint and the field of view of the user received from the client PC, select a high-quality texture as the texture, select a low-quality meshlet as a meshlet at a position not present in the field of view of the user, and select a low-quality texture as the texture; and a transmission processing unit that transmits the meshlet and the texture selected by the distribution control unit to the client PC.

### TECHNICAL FIELD

The present invention relates to a technique for distributing a three-dimensional video such as a volumetric video or a hologram.

### BACKGROUND ART

In three-dimensional video distribution that can be viewed from a free viewpoint by a virtual reality (VR)/augmented reality (AR) device represented by a volumetric video and a hologram, animation data of a point cloud or a polygon mesh is distributed to a client PC as three-dimensional video data, and is rendered together with a virtual environment in the client PC, displayed on an AR/VR display, and viewed by a user. FIG. 1 illustrates an example of (a) a point group and (b) a polygon mesh.

Normally, one person of the subject is regarded as one three-dimensional video, and the user views a plurality of three-dimensional videos in one content.

There is a subjective evaluation survey result that, when a point cloud that is a display format of a three-dimensional video is compared with a polygon mesh, the polygon mesh is superior in image quality (for example, Non Patent Literature 2). Therefore, it is considered that the three-dimensional video needs to be a polygon mesh for high image quality and a highly realistic environment.

Here, as a method of distributing the three-dimensional video, for example, there is a technology of transmitting content to a server in an existing cloud game service, dynamically rendering mesh data for each user in the server, and distributing the mesh data to the client PC. However, in this technology, it is necessary to perform rendering on the server for each user, and the server load is high.

In addition, in this technology, due to the change in the bandwidth status of the network, the change in the image quality on the screen of the AR/VR headset and the delay (Photon to Motion) from the sensor input to the time when the video is reflected become high, and thus it is not possible to realize AR/VR with high realistic environment and high image quality.

In addition, there is a technique of performing encoding and storage with a plurality of image qualities in a server using a three-dimensional video captured by a studio, and transmitting and reproducing from the server via a network in response to an image quality request from a client PC (for example, Non Patent Literature 1).

Therefore, it is conceivable to perform three-dimensional video distribution according to the network status and the field of view information of the headset using the distribution method of Non Patent Literature 1 or the like. In Non Patent Literature 1, data using point cloud data is divided by a plurality of cubic tiles, and the density of point clouds in the cubic tiles distributed using field of view information is controlled, so that a large number of three-dimensional videos are simultaneously displayed and transmission of data that is not in the field of view is reduced.

On the other hand, there is a technique of dynamically changing the number of polygon meshes required for rendering and rendering a more efficient complex scene by generating a meshlet in which polygon meshes on mesh data are bundled by shared vertices. FIG. 2 illustrates examples of (a) a mesh and (b) a meshlet. In FIG. 2(b), portions indicated by the same hatching indicate one meshlet.

In addition, as described in Non Patent Literature 3, it has also been studied to reduce the amount of data required for transmission by compressing the entire mesh data.

### CITATION LIST

### Non Patent Literature

Non Patent Literature 1: J. Park et al, “Rate-Utility Optimized Streaming of Volumetric Media for Augmented Reality,” arXiv:1804.09864, April 2018.
Non Patent Literature 2: E. Zerman et al, “Textured Mesh vs Coloured Point Cloud: A Subjective Study for Volumetric Video Compression,” 2020 Twelfth International Conference on Quality of Multimedia Experience (QoMEX), May 2020.
Non Patent Literature 3: “Darco 3D Data Compression” https://github.com/google/draco

### SUMMARY OF INVENTION

### Technical Problem

Since the expression of the three-dimensional video in the polygon mesh format gives high viewing quality to the user as compared with the point cloud data as shown in the experiment of Non Patent Literature 2, viewing in the polygon mesh format is desired for high-quality three-dimensional video experience.

However, in the technique described in Non Patent Literature 1, distribution using high-quality and lightweight polygon mesh data has not been studied. If the cubic tile division method proposed in Non Patent Literature 1 is applied to polygon mesh data, division occurs inside the mesh at the connection portion of the divided two cubic tiles, and the original shape is greatly changed, so that the quality is degraded. Furthermore, in the division in the cube, since there are cubes including dense meshes and cubes including sparse meshes, a difference occurs in the density of the meshes in the cube, the density is pulled by the sparse mesh in the cube, a cube with an assumed level of detail (LOD) cannot be generated, and the quality of the three-dimensional video is deteriorated.

In addition, a large amount of data needs to be transmitted to view content requiring a large number of three-dimensional videos at the same time, a server load increases, and a network cost increases because more bands are required.

In addition, as a method of compressing data, there is a method disclosed in Non Patent Literature 3, but in this method, compression is uniformly applied to the entire three-dimensional video, and thus the data of the three-dimensional video is transmitted regardless of the field of view and the viewpoint, and when the bandwidth of the network is small, the quality of the entire three-dimensional video is deteriorated.

That is, in the related art, a three-dimensional video with high viewing quality cannot be efficiently distributed.

The present invention has been made in view of the above points, and an object thereof is to provide a technique capable of efficiently distributing a three-dimensional video with high viewing quality.

### Solution to Problem

According to the disclosed technology, there is provided a distribution control device configured to distribute three-dimensional video data including a plurality of meshlets and a texture of each meshlet to a client PC, the device including
a distribution control unit configured to select a high-quality meshlet as a meshlet under a viewpoint of a user based on information regarding the viewpoint and the field of view of the user received from the client PC, select a high-quality texture as the texture thereof, select a low-quality meshlet as a meshlet at a position not present in the field of view of the user, and select a low-quality texture as the texture, and
a transmission processing unit that transmits the meshlet and the texture selected by the distribution control unit to the client PC.

### Advantageous Effects of Invention

According to the disclosed technology, there is provided a technology capable of efficiently distributing a three-dimensional video with high viewing quality.

### BRIEF DESCRIPTION OF DRAWINGS

FIG. 1 is a diagram illustrating an example of point cloud data and polygon mesh data.

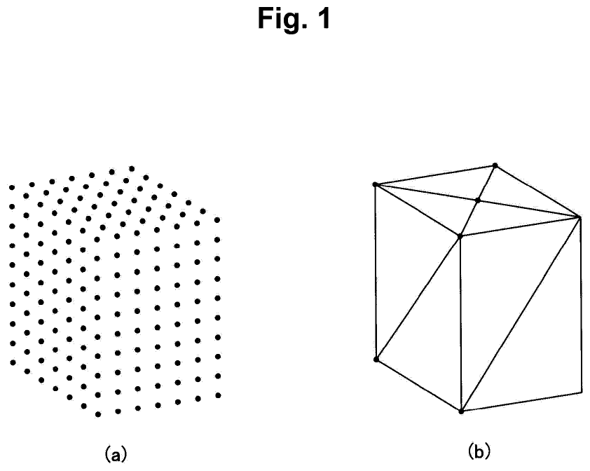

FIG. 2 is a diagram illustrating an example of a mesh and a meshlet.

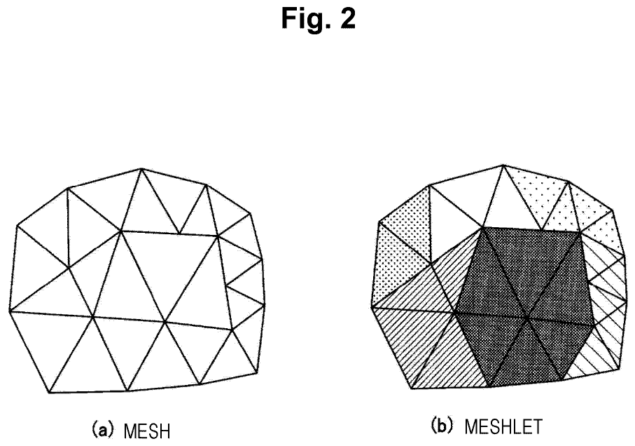

FIG. 3 is a system configuration diagram according to an embodiment of the present invention.

FIG. 4 is a diagram for illustrating creation of a meshlet and generation of a plurality of quality meshlets and textures.

FIG. 5 is a flowchart for illustrating an operation of distribution control.

FIG. 6 is a diagram for illustrating an example of a method of selecting an LOD and a compression ratio.

FIG. 7 is a diagram for illustrating a method of changing a configuration of distribution data.

FIG. 8 is a diagram illustrating creation of the meshlet and encoding thereof at a plurality of compression ratios.

FIG. 9 is a flowchart for illustrating an operation of distribution control.

FIG. 10 is a diagram for illustrating a method of changing a configuration of distribution data.

FIG. 11 is a diagram illustrating a hardware configuration example of a device.

### DESCRIPTION OF EMBODIMENTS

Hereinafter, an embodiment of the present invention (present embodiment) will be described with reference to the drawings. The embodiment described below is merely an example, and embodiments to which the present invention is applied are not limited to the following embodiment.

### Overview of Embodiment

In the present embodiment, a dynamic distribution control technology for controlling distribution of polygon mesh data using a network band, view information, viewpoint information, and the like will be described.

In the present embodiment, dynamic three-dimensional video distribution using polygon mesh data is realized by a system including a content server that stores a meshlet and a texture generated from a three-dimensional video in a plurality of resolutions, a distribution control server that performs distribution control on the basis of viewing facility information, network bandwidth information, viewpoint information, and the like of a user, a service site server that presents viewable content and guides the user to the server, and a client PC that receives and draws content.

Hereinafter, the configuration and operation of the system according to the embodiment of the present invention will be described in more detail. Hereinafter, a first embodiment and a second embodiment will be described. Note that an “LOD,” a “compression ratio,” and a “resolution” described below are all examples of the “quality”. A high LOD corresponds to a high quality, a low LOD corresponds to a low quality, a high compression ratio corresponds to a low quality, a low compression ratio corresponds to a high quality, a high resolution corresponds to a high quality, and a low resolution corresponds to a low quality.

### First Embodiment

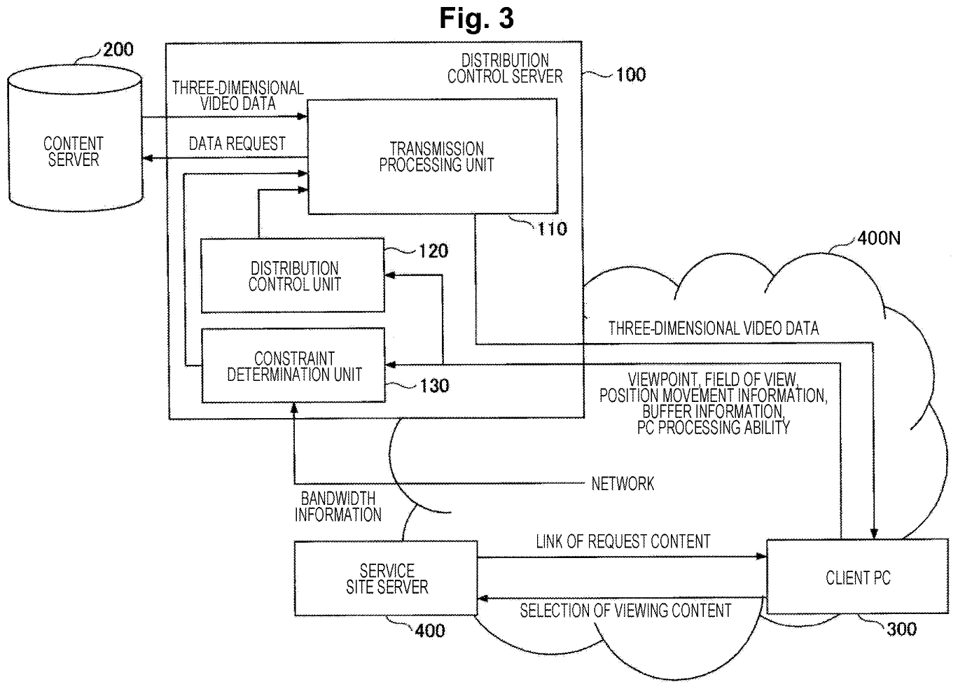

FIG. 3 is a system configuration diagram according to the first embodiment. As illustrated in FIG. 3, the system includes a content server 200, a distribution control server 100, a service site server 400, and a client PC 300. These devices are connected to a network 400 (for example, an IP network), and can perform data communication between the devices as illustrated in FIG. 3. Note that the distribution control server 100 may be referred to as a distribution control device. In addition, a system including the distribution control server 100 and the content server 200 may be referred to as a distribution control system.

As illustrated in FIG. 3, the distribution control server 100 includes a transmission processing unit 110, a distribution control unit 120, and a constraint determination unit 130. Operations of these functional units will be described later.

<Regarding Data Stored in Content Server>

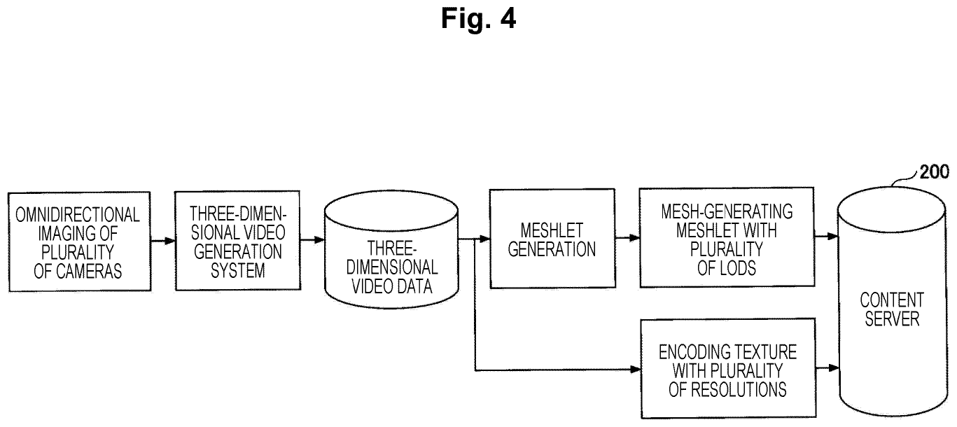

The content server 200 stores meshlets of a plurality of LODs and textures of a plurality of resolutions (a plurality of image qualities). A method for generating data stored in the content server 200 will be described with reference to FIG. 4. The generation processing of the data stored in the content server 200 is performed outside the content server 200, and the generated data is stored in the content server 200.

As illustrated in FIG. 4, omnidirectional imaging is performed by a plurality of cameras, and three-dimensional video data is generated by the three-dimensional video generation system. The three-dimensional video data includes polygon mesh data and its texture. The meshlet generation program generates a meshlet having a plurality of LODs at different levels from the three-dimensional video data, and the generated meshlet is stored in the content server 200. At the same time, the texture is divided for each meshlet, encoded at different levels of resolution, and stored in the content server 200. That is, the content server 200 stores the meshlets having LODs of a plurality of different levels corresponding to the three-dimensional video data and textures of a plurality of resolutions for each meshlet.

<Regarding Operation of System>

The operation of the system will be described with reference to FIG. 3.

The client PC 300 selects viewing content based on a link to the request content provided from the service site server 400.

In addition, the client PC 300 transmits information such as the resolution of the head mounted display and the processing capability of the PC to the distribution control server 100. In addition to these pieces of information, the client PC 300 sequentially transmits information indicating the movement of the position of the user in the virtual space, information indicating the size and position of the viewpoint and the field of view of the user, and the buffer amount in the client PC 300 to the distribution control server 100. The information transmitted from the client PC 300 to the distribution control server 100 is input to the distribution control unit 120 and the constraint determination unit 130. Note that the buffer amount is the size of the buffer, that is, the amount of data that can be buffered.

The wiring control server 100 acquires bandwidth usage information, server congestion information, and the like of the network 400 in addition to the information from the client PC 300, and performs distribution control.

More specifically, the distribution control unit 120 dynamically determines the LOD of the meshlet and the resolution of the texture from the viewpoint, the field of view, and the position movement information received from the client PC 300, and notifies the transmission processing unit 110 of the determined information. Furthermore, the constraint determination unit 130 determines a constraint on the amount of transmission data by using the bandwidth of the network and the buffer amount, and notifies the transmission processing unit 110 of information on the determined constraint.

The transmission processing unit 110 acquires the meshlet and the texture of the LOD determined by the distribution control unit 120 from the content server 200, and transmits the data of the meshlet and the texture of the three-dimensional video to the client PC 300 under the restriction of the transmission data amount determined by the constraint determination unit 130.

<Operation of Distribution Control Unit 120>

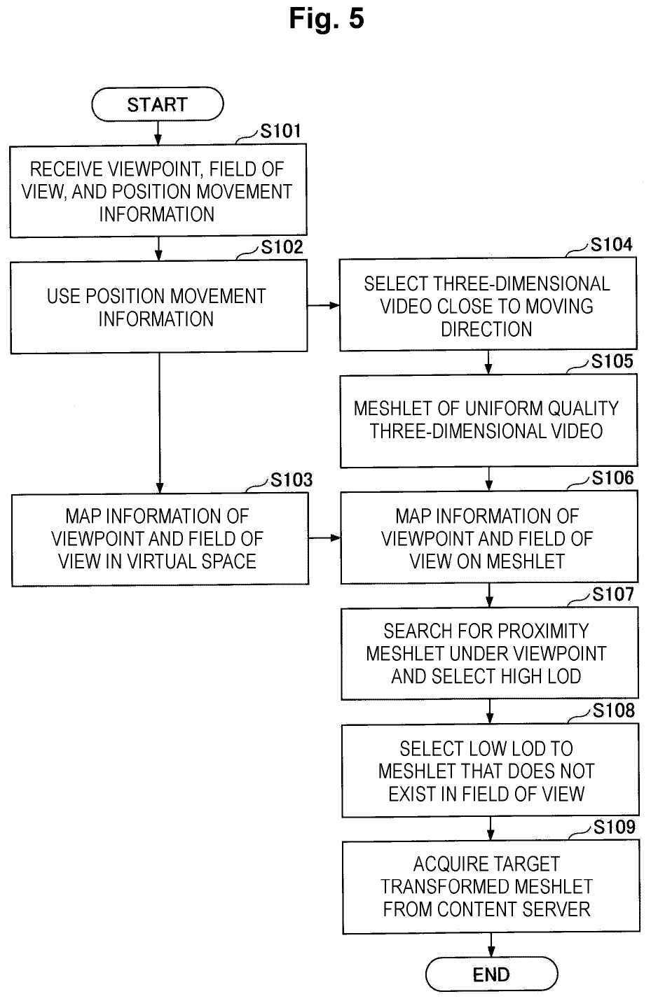

The operation of the distribution control unit 120 will be described in more detail with reference to the flowchart of FIG. 5. Note that it is assumed that the distribution control unit 120 holds the three-dimensional video, the meshlet of the three-dimensional video, and the like used for processing by the distribution control unit 120, or can acquire the meshlet and the like from the outside.

In S101, the distribution control unit 120 receives the viewpoint, the field of view, and the position movement information from the client PC 300. The distribution control unit 120 selects the three-dimensional video close to the moving direction of the user in the virtual space based on the position movement information, and generates a meshlet of a uniform quality three-dimensional video (S102, S104, and S105).

Furthermore, the distribution control unit 120 maps the information of the viewpoint and the field of view of the user in the virtual space (S103), and maps the information of the viewpoint and the field of view on the meshlet of the three-dimensional video (S106).

In S107, the distribution control unit 120 searches for a meshlet corresponding to a gaze point using the information of the viewpoint, and selects a meshlet under the viewpoint (a meshlet at the gaze point of the user) and a meshlet close thereto. Proximal meshlets may be selected from indices of vertices proximate the gaze point. The distribution control unit 120 determines to apply the high LOD and the high resolution texture to the meshlet under the viewpoint and its proximate meshlet. It may be determined to apply the high LOD and the high resolution texture to the meshlet under the viewpoint.

In S108, the distribution control unit 120 determines to apply the low LOD and the low resolution texture to the meshlet that is far away and does not exist in the field of view.

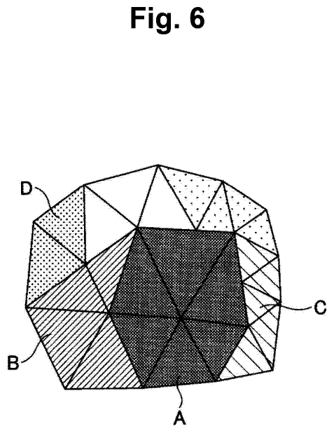

For example, in the example illustrated in FIG. 6, assuming that the meshlet indicated by A is a meshlet with a gaze point and that B and C are meshlets close to A in the field of view, it is determined that the high LOD and high resolution texture is applied to A, B, and C. In addition, when the meshlet indicated by D is a meshlet not present in the field of view, it is determined to apply the low LOD and low resolution texture thereto.

The distribution control unit 120 may determine to apply the medium LOD and medium resolution texture to the meshlet that is within the field of view but is away from the gaze point. Furthermore, the distribution control unit 120 may use the position moving speed and the moving acceleration information of the user to improve the resolution of the LOD and the texture of the meshlet with respect to the three-dimensional video in which the user approaches, and reduce the resolution of the LOD and the texture with respect to the three-dimensional video in which the user moves away.

In S109, the distribution control unit 120 passes the resolution of the LOD and the texture for each meshlet determined as described above to the transmission processing unit 110, and the transmission processing unit 110 acquires the meshlet of the LOD and the texture of the resolution from the content server 200.

In the above example, the LOD and the resolution are classified into “high” and “low,” or “high,” “medium,” and “low,” but these are merely examples. More levels may be classified.

<Operation of Constraint Determination Unit 130>

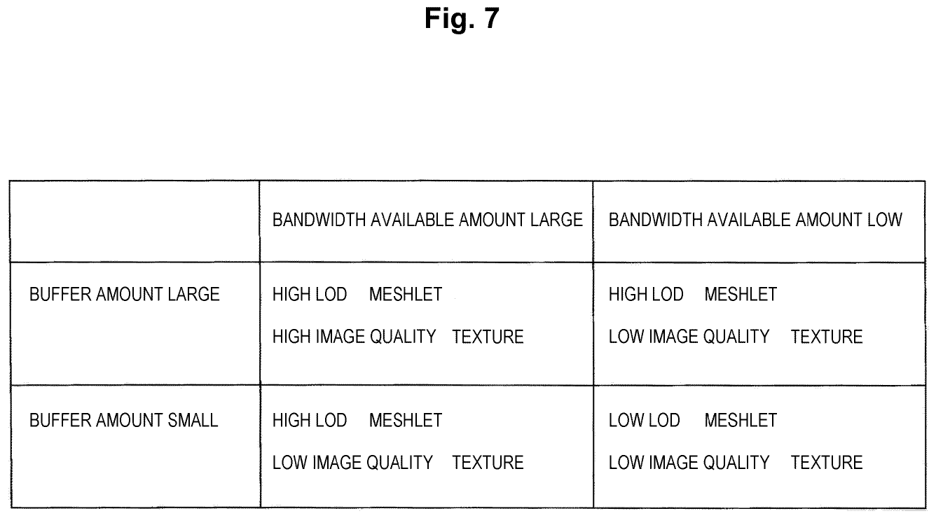

Next, an operation of the constraint determination unit 130 will be described with reference to FIG. 7. The Constraint determination unit 130 can further change the configuration of the distribution data with respect to the configuration of the distribution data determined by the distribution control unit 120 based on the bandwidth information of the network 400 and the buffer amount in the client PC 300. Note that the constraint determination unit 130 may acquire the network bandwidth information from an intermediary switch in the network 400 or from an access status to the distribution control server 100. The buffer amount can be acquired from the client PC 300.

In the following description, a certain amount being “large” means that, for example, the amount is larger than a certain threshold value. A certain amount being “small” means, for example, that the amount is smaller than a certain threshold value.

As illustrated in FIG. 7, when the buffer amount is large and the network bandwidth available amount is large, the constraint determination unit 130 determines to transmit the meshlet with the high LOD and the texture with high image quality to the client PC 300, and notifies the transmission processing unit 110 of the determination content.

When the buffer amount is small and the bandwidth available amount is large, the constraint determination unit 130 determines to transmit the meshlet with the high LOD and the texture with low image quality to the client PC 300, and notifies the transmission processing unit 110 of the determination content. When the buffer amount is large and the bandwidth available amount is low, the constraint determination unit 130 determines to transmit the meshlet with the high LOD and the texture with the low image quality to the client PC 300, and notifies the transmission processing unit 110 of the determination content.

In addition, when both the buffer amount and the bandwidth available amount are low, the constraint determination unit 130 determines to transmit the low LOD meshlet and the low quality texture to the client PC 300, and notifies the transmission processing unit 110 of the determination content.

The transmission processing unit 110 determines distribution data to be transmitted to the client PC 300 with the LOD and the image quality (resolution) received from the constraint determination unit 130 as constraints. For example, even in a case where the distribution control unit 120 determines to distribute the “high LOD meshlet and high quality texture,” in a case where the LOD and the image quality received from the constraint determination unit 130 are the “low LOD meshlet and low quality texture,” the “low LOD meshlet and low quality texture” is acquired from the content server 200 instead of the “high LOD meshlet and high quality texture,” and is distributed to the client PC 300.

By the distribution control unit 120 and the constraint determination unit 130 described above, the distribution control server 100 selects an appropriate LOD of the meshlet and resolution of the texture, acquires the pre-converted data from the content server 200, and transmits the pre-converted data to the client PC 300.

The client PC 300 renders the meshlet and texture data of the received three-dimensional video and performs rendering on the head mounted display.

### Second Embodiment

Next, a second embodiment will be described. A system configuration in the second embodiment is the same as the system configuration in the first embodiment as illustrated in FIG. 3.

<Regarding Data Stored in Content Server>

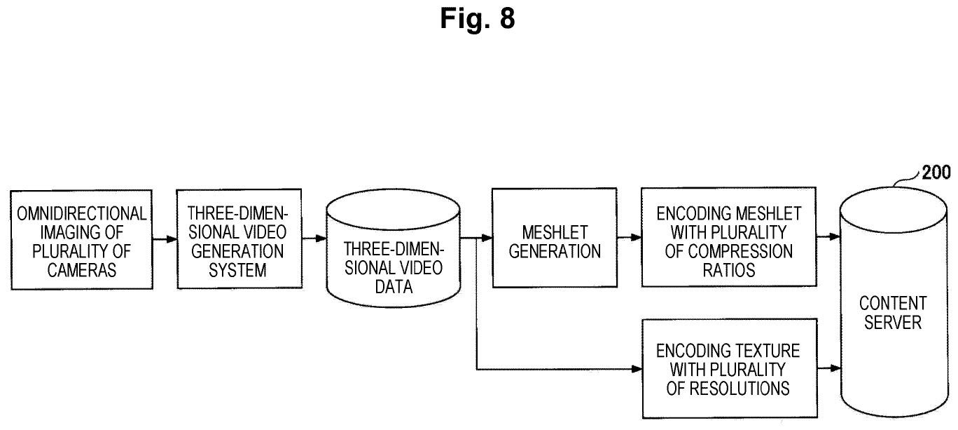

The content server 200 stores meshlets of a plurality of compression ratios and textures of a plurality of resolutions (a plurality of image qualities). A method for generating data stored in the content server 200 will be described with reference to FIG. 8. The generation processing of the data stored in the content server 200 is performed outside the content server 200, and the generated data is stored in the content server 200.

As illustrated in FIG. 8, omnidirectional imaging is performed by a plurality of cameras, and three-dimensional video data is generated by the three-dimensional video generation system. The three-dimensional video data includes polygon mesh data and its texture. The meshlet generation program generates a meshlet from the three-dimensional video data, encodes the meshlet with a plurality of different compression ratios, and stores the encoded meshlet in the content server 200. At the same time, the texture is divided for each meshlet, encoded at different levels of resolution, and stored in the content server 200. That is, the content server 200 stores meshlets encoded at a plurality of different compression ratios corresponding to three-dimensional video data, and textures of a plurality of resolutions for each meshlet.

<Regarding Operation of System>

The overall operation of the system in the second embodiment is the same as that in the first embodiment. That is, the client PC 300 selects viewing content based on a link to the request content provided from the service site server 400.

In addition, the client PC 300 transmits information such as the resolution of the head mounted display and the processing capability of the PC to the distribution control server 100. In addition to these pieces of information, the client PC 300 sequentially transmits information indicating the movement of the position of the user in the virtual space, information indicating the size and position of the viewpoint and the field of view of the user, and the buffer amount in the client PC 300 to the distribution control server 100. The information transmitted from the client PC 300 to the distribution control server 100 is input to the distribution control unit 120 and the constraint determination unit 130.

The wiring control server 100 acquires bandwidth usage information, server congestion information, and the like of the network 400 in addition to the information from the client PC 300, and performs distribution control.

More specifically, the distribution control unit 120 dynamically determines the compression ratio of the meshlet and the resolution of the texture from the viewpoint, the field of view, and the position movement information received from the client PC 300, and notifies the transmission processing unit 110 of the determined information. Furthermore, the constraint determination unit 130 determines a constraint on the amount of transmission data by using the bandwidth of the network and the buffer amount, and notifies the transmission processing unit 110 of information on the determined constraint.

The transmission processing unit 110 acquires the meshlet and the texture of the compression ratio determined by the distribution control unit 120 from the content server 200, and transmits the data of the meshlet and the texture of the three-dimensional video to the client PC 300 under the restriction of the transmission data amount determined by the constraint determination unit 130.

<Operation of Distribution Control Unit 120>

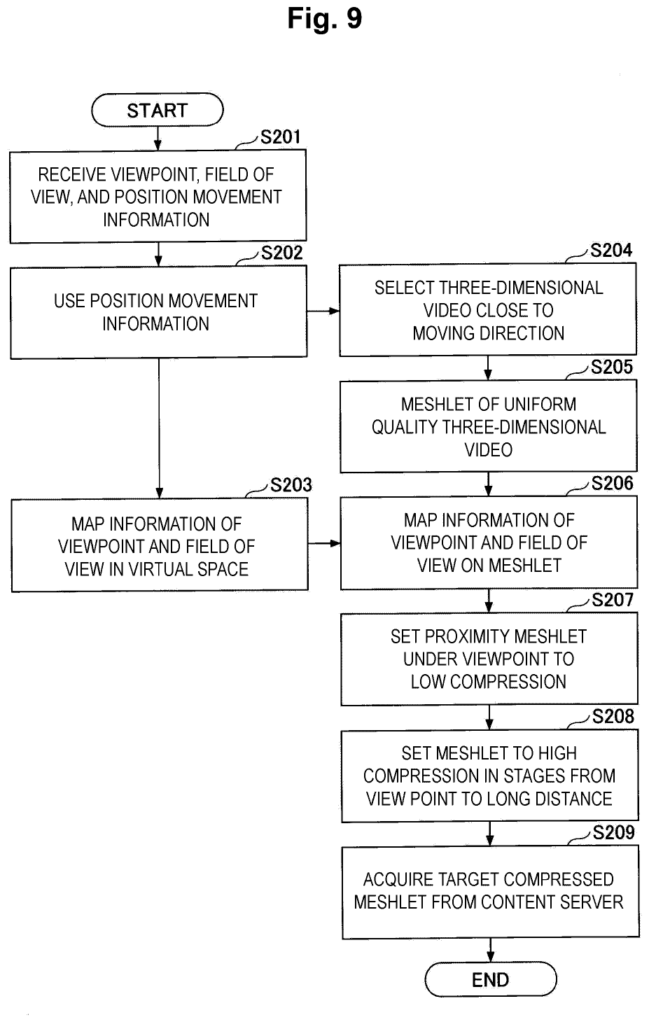

The operation of the distribution control unit 120 will be described in more detail with reference to the flowchart of FIG. 9. Note that it is assumed that the distribution control unit 120 holds the three-dimensional video, the meshlet of the three-dimensional video, and the like used for processing by the distribution control unit 120, or can acquire the meshlet and the like from the outside.

In S201, the distribution control unit 120 receives the viewpoint, the field of view, and the position movement information from the client PC 300. The distribution control unit 120 selects the three-dimensional video close to the moving direction of the user in the virtual space based on the position movement information, and generates a meshlet of a uniform quality three-dimensional video (S202, S204, and S205).

Furthermore, the distribution control unit 120 maps the information of the viewpoint and the field of view of the user in the virtual space (S203), and maps the information of the viewpoint and the field of view on the meshlet of the three-dimensional video (S206).

In S207, the distribution control unit 120 searches for a meshlet corresponding to a gaze point using the information of the viewpoint, and selects a meshlet under the viewpoint (a meshlet at the gaze point of the user) and a meshlet close thereto. Proximal meshlets may be selected from indices of vertices proximate the gaze point. The distribution control unit 120 determines to apply the low compression ratio and the high resolution texture to the meshlet under the viewpoint and its proximate meshlet. It may be determined to apply the low compression ratio and the high resolution texture to the meshlet under the viewpoint.

In S208, the distribution control unit 120 determines to apply the high compression ratio and the low resolution texture to the meshlet that is far away and does not exist in the field of view. More specifically, a high compression ratio meshlet (and a low resolution texture) may be applied stepwise as the distance from the viewpoint increases.

For example, in the example illustrated in FIG. 6, assuming that the meshlet indicated by A is a meshlet with a gaze point and that B and C are meshlets close to A in the field of view, it is determined that the low compression ratio meshlet and high resolution texture is applied to A, B, and C. In addition, when the meshlet indicated by D is a meshlet not present in the field of view, it is determined to apply the high compression ratio meshlet and low resolution texture thereto.

The distribution control unit 120 may determine to apply the medium compression ratio and medium resolution texture to the meshlet that is within the field of view but is away from the gaze point. In addition, the distribution control unit 120 may use the position moving speed and the moving acceleration information of the user to reduce the compression ratio of the meshlet for the three-dimensional video to which the user approaches to improve the resolution of the texture, and to improve the compression ratio of the meshlet for the three-dimensional video to which the user moves away to reduce the resolution of the texture.

In S209, the distribution control unit 120 passes the resolution of the compression ratio and the texture for each meshlet determined as described above to the transmission processing unit 110, and the transmission processing unit 110 acquires the meshlet of the compression ratio and the texture of the resolution from the content server 200.

In the above example, the compression ratio and the resolution are classified into “high” and “low,” or “high,” “medium,” and “low,” but these are merely examples. More levels may be classified.

<Operation of Constraint Determination Unit 130>

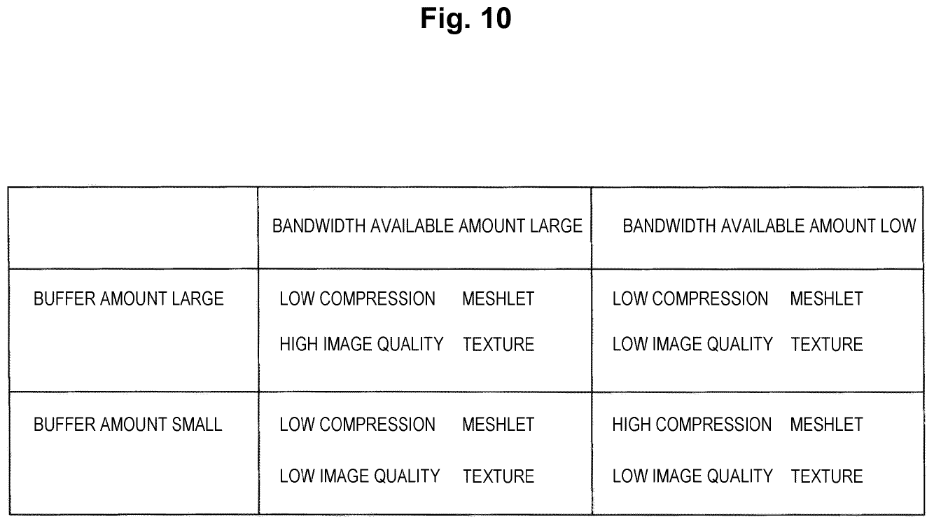

Next, an operation of the constraint determination unit 130 will be described with reference to FIG. 10. The Constraint determination unit 130 can further change the configuration of the distribution data with respect to the configuration of the distribution data determined by the distribution control unit 120 based on the bandwidth information of the network 400 and the buffer amount in the client PC 300. Note that the constraint determination unit 130 may acquire the network bandwidth information from an intermediary switch in the network 400 or from an access status to the distribution control server 100. The buffer amount can be acquired from the client PC 300.

In the following description, a certain amount being “large” means that, for example, the amount is larger than a certain threshold value. A certain amount being “small” means, for example, that the amount is smaller than a certain threshold value.

As illustrated in FIG. 10, when the buffer amount is large and the network bandwidth available amount is large, the constraint determination unit 130 determines to transmit the meshlet with the low compression ratio and the texture with high image quality to the client PC 300, and notifies the transmission processing unit 110 of the determination content.

Similarly, when the buffer amount is small and the bandwidth available amount is large, the constraint determination unit 130 determines to transmit the meshlet with the low compression ratio and the texture with low image quality to the client PC 300, and notifies the transmission processing unit 110 of the determination content. When the buffer amount is large and the bandwidth available amount is low, the constraint determination unit 130 determines to transmit the meshlet with the low compression ratio and the texture with the low image quality to the client PC 300, and notifies the transmission processing unit 110 of the determination content.

In addition, when both the buffer amount and the bandwidth available amount are low, the constraint determination unit 130 determines to transmit the high compression ratio meshlet and the low quality texture to the client PC 300, and notifies the transmission processing unit 110 of the determination content.

The transmission processing unit 110 determines distribution data to be transmitted to the client PC 300 with the compression ratio and the image quality (resolution) received from the constraint determination unit 130 as constraints. For example, even in a case where the distribution control unit 120 determines to distribute the “low compression ratio meshlet and high quality texture,” in a case where the LOD and the image quality received from the constraint determination unit 130 are the “high compression ratio meshlet and low quality texture,” the “high compression ratio meshlet and low quality texture” is acquired from the content server 200 instead of the “low compression ratio meshlet and high quality texture,” and is distributed to the client PC 300.

By the distribution control unit 120 and the constraint determination unit 130 described above, the distribution control server 100 selects an appropriate compression ratio of the meshlet and resolution of the texture, acquires the pre-converted data from the content server 200, and transmits the pre-converted data to the client PC 300.

The client PC 300 renders the meshlet and texture data of the received three-dimensional video and performs rendering on the head mounted display.

(Hardware Configuration Example)

Any of the devices (distribution control server, content server, service site server, and client PC) described in the present embodiment can be realized, for example, by causing a computer to execute a program describing processing contents described in the present embodiment.

The above program can be stored and distributed by being recorded in a computer-readable recording medium (portable memory or the like). Furthermore, the above program can also be provided through a network such as the Internet or an electronic mail.

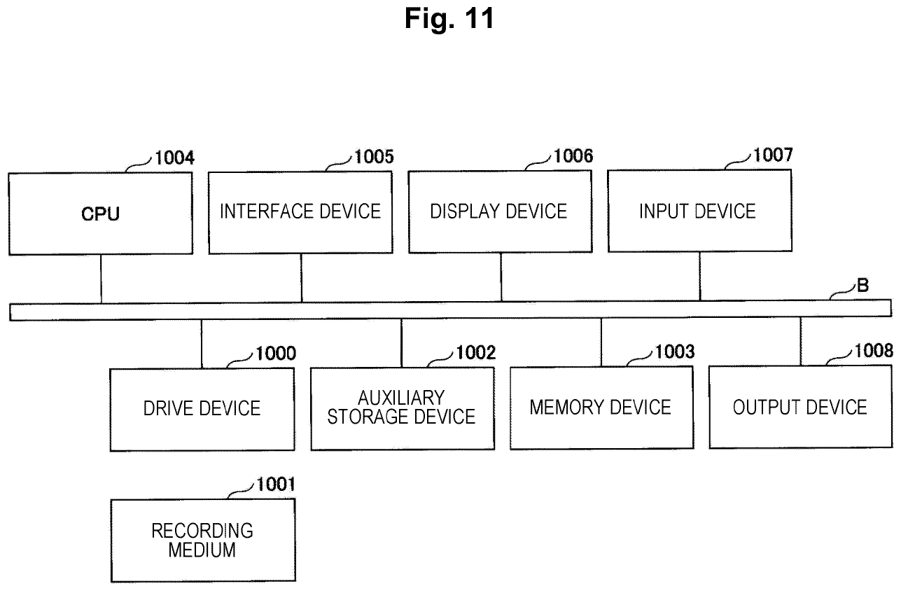

FIG. 11 is a diagram illustrating a hardware configuration example of the computer. The computer in FIG. 11 includes a drive device 1000, an auxiliary storage device 1002, a memory device 1003, a CPU 1004, an interface device 1005, a display device 1006, an input device 1007, an output device 1008, and the like which are connected to each other by a bus B.

The program for implementing the processing in the computer is provided by a recording medium 1001 such as a CD-ROM or a memory card. When the recording medium 1001 that stores the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program and also stores necessary files, data, and the like.

In a case where an instruction to start the program is made, the memory device 1003 reads and stores the program from the auxiliary storage device 1002. The CPU 1004 implements a function related to the device in accordance with a program stored in the memory device 1003. The interface device 1005 is used as an interface for connecting to the network. The display device 1006 displays a graphical user interface (GUI) or the like by the program. The input device 1007 includes a keyboard and mouse, buttons, a touch panel, or the like, and is used to input various operation instructions. The output device 1008 outputs a calculation result.

### Effects of Embodiment

As described above, according to the technology of the present embodiment, the three-dimensional video data is reconstructed into a plurality of pieces of video quality data in the server, and the video data of the portion necessary for the viewing on the client PC side is transmitted by selecting the video quality based on the viewpoint, the field of view, and the state of the network, so that the three-dimensional video with high viewing quality can be distributed with a small server load and a small amount of communication data.

### Summary of Embodiment

The present specification discloses at least the distribution control device, the distribution control system, the distribution control method, and the program according to the following clauses.

(Clause 1)

A distribution control device configured to distribute three-dimensional video data including a plurality of meshlets and a texture of each meshlet to a client PC, the device including:
a distribution control unit configured to select a high-quality meshlet as a meshlet under a viewpoint of a user based on information regarding the viewpoint and the field of view of the user received from the client PC, select a high-quality texture as the texture, select a low-quality meshlet as a meshlet at a position not present in the field of view of the user, and select a low-quality texture as the texture; and
a transmission processing unit that transmits the meshlet and the texture selected by the distribution control unit to the client PC.

(Clause 2)

The distribution control device according to clause 1, further including:
a constraint determination unit configured to determine a constraint on data to be transmitted to the client PC based on a bandwidth available amount of a network connecting the distribution control device and the client PC and a buffer amount of the client PC.

(Clause 3)

The distribution control device according to clause 1 or 2, in which the quality of the meshlet is an LOD or a compression ratio, and the quality of the texture is a resolution.

(Clause 4)

A distribution control system including:
the distribution control device according to any one of clauses 1 to 3; and
a content server storing a plurality of quality meshlets and a plurality of quality textures, in which
the distribution control unit acquires the selected meshlet and texture from the content server.

(Clause 5)

A distribution control method executed by a distribution control device configured to distribute three-dimensional video data including a plurality of meshlets and a texture of each meshlet to a client PC, the method including:
a distribution control step of selecting a high-quality meshlet as a meshlet under a viewpoint of a user based on information regarding the viewpoint and the field of view of the user received from the client PC, selecting a high-quality texture as the texture, selecting a low-quality meshlet as a meshlet at a position not present in the field of view of the user, and selecting a low-quality texture as the texture; and
a transmission processing step of transmitting the meshlet and the texture selected by the distribution control step to the client PC.

(Clause 6)

A program for causing a computer to function as each unit in the distribution control device according to any one of clauses 1 to 3.

Although the present embodiment has been described above, the present invention is not limited to such a specific embodiment, and various modifications and changes can be made within the scope of the gist of the present invention described in the claims.

### REFERENCE SIGNS LIST

100 Distribution control server
110 Transmission processing unit
120 Distribution control unit
130 Constraint determination unit
200 Content Server
300 Client PC
400 Service site server
1000 Drive device
1001 Recording medium
1002 Auxiliary storage device
1003 Memory device
1004 CPU
1005 Interface device
1006 Display device
1007 Input device

1. A distribution control device configured to distribute three-dimensional video data including a plurality of meshlets and a texture of each meshlet to a client PC, the distribution control device comprising:
a hardware processor configured to
select a high-quality meshlet as a meshlet under a viewpoint of a user based on information regarding the viewpoint and the field of view of the user received from the client PC, select a high-quality texture as the texture, select a low-quality meshlet as a meshlet at a position not present in the field of view of the user, and select a low-quality texture as the texture; and
transmit the selected meshlet and texture to the client PC.

2. The distribution control device according to claim 1, wherein
the hardware processor is further configured to determine a constraint on data to be transmitted to the client PC based on a bandwidth available amount of a network connecting the distribution control device and the client PC and a buffer amount of the client PC.

3. The distribution control device according to claim 1, wherein the quality of the meshlet is an LOD or a compression ratio, and the quality of the texture is a resolution.

4. A distribution control system comprising:
the distribution control device according to claim 1; and
a content server storing a plurality of quality meshlets and a plurality of quality textures, wherein
the hardware processor is configured to acquire the selected meshlet and texture from the content server.

5. A distribution control method executed by a distribution control device configured to distribute three-dimensional video data including a plurality of meshlets and a texture of each meshlet to a client PC, the distribution control method comprising:
selecting a high-quality meshlet as a meshlet under a viewpoint of a user based on information regarding the viewpoint and the field of view of the user received from the client PC, selecting a high-quality texture as the texture, selecting a low-quality meshlet as a meshlet at a position not present in the field of view of the user, and selecting a low-quality texture as the texture; and
transmitting the selected meshlet and texture to the client PC.

6. A non-transitory computer-readable recording medium storing a program for causing a computer to function as the distribution control device according to claim 1.
